(19) United States
(12) Patent Application Publication
(10) Pub. No.: US 2025/0251191 A1
(43) Pub. Date: Aug. 7, 2025

(54) DRYING DEVICE AND RECORDING DEVICE

(71) Applicant: SEIKO EPSON CORPORATION, Tokyo (JP)

(72) Inventor: Tadashi AIZAWA, MATSUMOTO-SHI (JP)

(21) Appl. No.: 19/045,872

(22) Filed: Feb. 5, 2025

(30) Foreign Application Priority Data
Feb. 6, 2024 (JP) 2024-016179

(51) Int. Cl. F26B 3/347; B41J 11/00

(52) U.S. Cl. CPC F26B 3/347; B41J 11/00218

(57) ABSTRACT

The drying device includes a drying section that dries the medium onto which liquid is ejected, by generating electromagnetic waves according to on an applied high-frequency voltage. The drying section includes a first electrode, a second electrode arranged so as to surround the first electrode in plan view from a first direction toward a medium, a first conductor electrically connecting the first electrode to a transmission line including a coil and configure to transmit a high-frequency voltage, and a second conductor electrically coupling the transmission line and the second electrode. The first electrode includes a first electrode section arranged at a position overlapping the second electrode in the first direction and a second electrode section that is arranged at a position that does not overlap the second electrode in the first direction and that is separated from the medium, and that surrounds the first electrode section in plan view from the first direction.

The present application is based on, and claims priority from JP Application Serial Number 2024-016179, filed Feb. 6, 2024, the disclosure of which is hereby incorporated by reference herein in its entirety.

### BACKGROUND

### 1. Technical Field

The present disclosure relates to a drying device and a recording device.

### 2. Related Art

For example, a drying device that dries a medium by generating electromagnetic waves on the medium on which liquid has been ejected is disclosed in JP-A-2022-39286. Such a drying device generates an electromagnetic wave with respect to the medium by supplying a high-frequency voltage between the first electrode and the second electrode. By this, it can dry the medium onto which is ejected liquid.

However, in such a drying device, a strong electric field region tends to be concentrated on both end sections of the first electrode. For this reason, there was a risk that the drying degree of the medium may become uneven.

### SUMMARY

To solve the above problem, a drying device includes a drying section that dries the medium onto which liquid is ejected, by generating electromagnetic waves according to on an applied high-frequency voltage, wherein the drying section includes a first electrode, a second electrode arranged so as to surround the first electrode in plan view from a first direction toward a medium, a conductor electrically connecting the first electrode to a transmission line including a coil and configured to transmit a high-frequency voltage, and a second conductor electrically coupling the transmission line and the second electrode, and the first electrode includes a first electrode section arranged at a position overlapping the second electrode in the first direction and a second electrode section arranged at a position that does not overlap the second electrode in the first direction and that is separated from the medium in the first direction, the second electrode section surrounding the first electrode section in plan view from the first direction.

To solve the above problem, a recording device includes a recording section configured to perform recording by ejecting liquid onto a medium and a drying section that dries the medium, onto which liquid was ejected by the recording section, by generating electromagnetic waves according to an applied high-frequency voltage, wherein the drying section has a first electrode, a second electrode arranged so as to surround the first electrode in plan view from a first direction toward a medium, a first conductor electrically connecting the first electrode to a transmission line including a coil and configured to transmit a high-frequency voltage, and a second conductor electrically coupling the transmission line and the second electrode, and the first electrode includes a first electrode section arranged at a position overlapping the second electrode in the first direction and a second electrode section arranged at a position that does not overlap the second electrode in the first direction and that is separated from the medium in the first direction, the second electrode section surrounding the first electrode section in plan view from the first direction.

### BRIEF DESCRIPTION OF THE DRAWINGS

FIG. 1 is a schematic diagram illustrating a recording system according to a first embodiment.

FIG. 2 is a perspective view showing the drying section according to the first embodiment.

FIG. 3 is a perspective view showing the first electrode of the first embodiment.

FIG. 4 is a front view showing the first electrode and the second electrode of the first embodiment.

FIG. 5 is a plan view showing the first electrode and the second electrode of the first embodiment.

FIG. 6 is an explanatory view showing the heating amount of the first embodiment.

### DESCRIPTION OF EMBODIMENTS

### First Embodiment

Hereinafter, an embodiment of a recording system including a drying device and a recording device will be described.

In the following description, a direction intersecting the vertical direction Z is referred to as a width direction X, and a direction intersecting the vertical direction Z and the width direction X is referred to as a depth direction Y. One direction along the width direction X is defined as the first width direction X1, and the other direction along the width direction X is defined as the second width direction X2. One direction along the depth direction Y is defined as the first depth direction Y1, and the other direction along the depth direction Y is defined as the second depth direction Y2. The side in the vertical direction Z that is upward is referred to as upward direction Z1, and the side in the vertical direction Z that is downward is referred to as downward direction Z2. The vertical direction Z corresponds to an example of a first direction. The width direction X corresponds to an example of a second direction. The depth direction Y corresponds to an example of a third direction.

### Configuration of Recording System 10

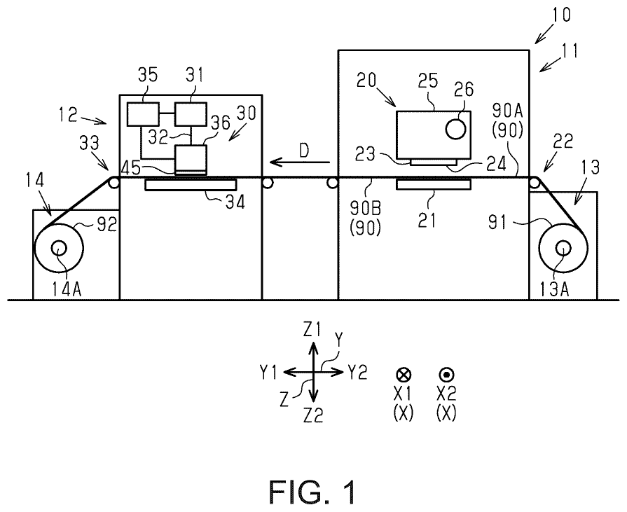

As shown in FIG. 1, a recording system 10 is a system that performs recording on medium 90. In particular, the recording system 10 is a system that performs recording on the medium 90 by ejecting liquid onto the medium 90. The recording system 10 is a system that dries the medium 90, on which recording has been performed by ejecting liquid.

The recording system 10 includes a recording device 11. The recording device 11 is configured to perform recording on the medium 90. In particular, the recording device 11 performs recording on the medium 90 by ejecting liquid onto the medium 90. The recording device 11 may be an inkjet printer that performs recording by ejecting liquid such as ink onto the medium 90. The medium 90 includes a surface 90A and a back surface 90B. The medium 90 is a fabric, but it may also be, for example, paper.

The recording system 10 includes a drying device 12. The drying device 12 is configured to dry the medium 90 after the recording device 11 has ejected liquid onto it. In particular, the drying device 12 dries the medium 90 after recording by generating electromagnetic waves.

The recording system 10 includes a feeding section 13. The feeding section 13 feeds the medium 90 before recording to the recording device 11. The feeding section 13 includes a feed roller 13A. The feed roller 13A extends along the width direction X. In the width direction X, the width of the feed roller 13A is longer than the width of the medium 90. The feed roller 13A is configured to rotatably hold a first roll body 91. The first roll body 91 is the medium 90 that is wound and rolled before recording. The medium 90 may be elongated. In this way, the feed roller 13A holds the medium 90 to be fed to the recording device 11.

The recording system 10 includes a winding section 14. The winding section 14 winds the medium 90 after recording by the recording device 11. In particular, the winding section 14 winds the medium 90 after recording, which is dried by the drying device 12. The winding section 14 includes a winding roller 14A. The winding roller 14A extends along the width direction X. In the width direction X, the width of the winding roller 14A is longer than the width of the medium 90. The winding roller 14A is configured to rotatably hold a second roll body 92. The second roll body 92 is the medium 90 that is wound and rolled after recording. In this way, the winding roller 14A winds the medium 90 that has been recorded by the recording device 11 and dried by the drying device 12.

### Configuration of Recording Device 11

Here, the configuration of recording device 11 will be described in detail.

The recording device 11 includes a recording section 20, a recording-medium support section 21, and a recording-medium transport section 22. The recording section 20 is configured to perform recording on the medium 90 by ejecting liquid onto the medium 90. The recording section 20 is configured to perform recording on the medium 90 by ejecting liquid onto the surface 90A of the medium 90. The recording section 20 performs recording on the medium 90 supported by the recording-medium support section 21. The recording section 20 performs recording on the medium 90 transported by the recording-medium transport section 22.

The recording section 20 includes a head 23. The head 23 may be a serial head or may be a line head. The serial head is a head that scans in the width direction X of the medium 90. The line head is a head that performs recording all at once in the width direction X of the medium 90.

The head 23 includes a nozzle surface 24 in which a plurality of nozzles (not shown) is opened. The nozzle surface 24 is a surface facing the downward direction Z2. The nozzle surface 24 is a surface facing the surface 90A of the medium 90 transported by the recording-medium transport section 22. Each of the plurality of nozzles is configured to open to the downward direction Z2. Each of the plurality of nozzles is configured to eject a liquid.

The recording section 20 may include a carriage 25 and a carriage support section 26. The carriage 25 is configured to support the head 23. The carriage support section 26 extends along the width direction X. The carriage support section 26 supports the carriage 25 so as to be movable along the width direction X. The carriage 25 is movable in the width direction X along the carriage support section 26 by a driving force from a drive source (not shown).

The recording-medium support section 21 is configured to support the medium 90 transported by the recording-medium transport section 22. The recording-medium support section 21 is positioned in the downward direction 22 of the recording section 20. The recording-medium support section 21 supports the back surface 90B of the medium 90 transported by the recording-medium transport section 22. The recording-medium support section 21 is positioned in the downward direction 22 of the head 23.

The recording-medium transport section 22 is configured to transport the medium 90 in the transport direction D. The transport direction D is a direction along the depth direction Y. The recording-medium transport section 22 may include a plurality of rollers. The recording-medium transport section 22 transports the medium 90 in the transport direction D using a plurality of rollers but may also transport the medium 90 in the transport direction D using a transport belt driven by a plurality of rollers. The recording-medium transport section 22 may perform intermittent transport in which the transport and stop of the medium 90 are repeated.

### Configuration of the Drying Device 12

Next, the configuration of drying device 12 will be described in detail.

The drying device 12 includes a drying unit 30. The drying unit 30 is configured to dry the medium 90 after recording. That is, the drying device 12 sets the medium 90 on which recording is performed by the recording section 20 as a drying target.

The drying unit 30 is configured to dry the medium 90 after recording by generating electromagnetic waves. The drying unit 30 is located in the upward direction Z1 of the medium 90 but may be located in the downward direction 22 of the medium 90 or may be located in both the upward direction 21 and the downward direction 22 of the medium 90. In this way, the vertical direction Z is a direction toward the medium 90.

The drying device 12 includes a high-frequency voltage generation section 31. The high-frequency voltage generation section 31 is configured to generate a high-frequency voltage. The high-frequency voltage generation section 31 supplies a high-frequency voltage to the drying unit 30 via a transmission line 32.

The transmission line 32 is a line that couples the drying unit 30 and the high-frequency voltage generation section 31. The transmission line 32 can transmit the high-frequency voltage from the high-frequency voltage generation section 31 to the drying unit 30. That is, the transmission line 32 can transmit a high-frequency voltage.

The transmission line 32 may be a coaxial cable but is not limited to a coaxial cable. The transmission line 32 may include a first line and a second line. The first line may be a core wire of the transmission line 32. The second line may be an electromagnetic shield that covers the first line.

The drying device 12 includes a drying transport section 33. The drying transport section 33 is configured to transport the medium 90 in the transport direction D. The drying transport section 33 may transport the medium 90 in the transport direction D using a plurality of rollers. The drying transport section 33 may perform continuous transport in which the medium 90 is continuously transported. The medium 90 may be slackened between the recording-medium transport section 22 and the drying transport section 33.

The drying device 12 includes a drying support section 34. The drying support section 34 is configured to support the medium 90 transported by the drying transport section 33. The drying support section 34 is located in the downward direction Z2 of the drying unit 30. The drying support section 34 supports the back surface 90B of the medium 90 transported by the drying transport section 33. The drying support section 34 is positioned in the downward direction 22 of a drying section 36 to be described later.

The drying device 12 includes a control section 35. The control section 35 controls the drying device 12. Specifically, the control section 35 controls the drying unit 30. The control section 35 controls the high-frequency voltage generation section 31. The control section 35 controls the drying transport section 33.

The control section 35 may be constituted by one or more processors that execute various processes in accordance with a computer program. The control section 35 may be constituted by one or more dedicated hardware circuits. The control section 35 may be configured by an application-specific integrated circuit that executes at least a part of various processes. The control section 35 may be configured by a circuit including a combination of a processor and a hardware circuit. The processor includes a CPU and memories such as a RAM and a ROM. The memory stores program code or commands configured to cause the CPU to perform processes. Memory, in other words, computer-readable medium, includes any medium that can be accessed by a general purpose or special purpose computer.

The drying unit 30 includes the drying section 36. In other words, the drying device 12 includes the drying section 36. The drying unit 30 may include a plurality of drying sections 36. The drying section 36 may have a rectangular shape in plan view from the vertical direction Z. The drying section 36 may be arranged so that the width direction X is the longitudinal direction. Hereinafter, a plan view from the vertical direction z is simply referred to as a plan view.

The drying section 36 is configured to generate an electromagnetic wave depending on the application of a high-frequency voltage. The drying section 36 generates an electromagnetic wave depending on the application of a high-frequency voltage. By this, the drying section 36 is configured to dry the medium 90 onto which the liquid has been ejected by the recording section 20. The drying section 36 is an electromagnetic wave generation section.

The drying section 36 generates an AC electric field by generating an electromagnetic wave. The electromagnetic wave generated by the drying section 36 has an electric field as the main component. The drying section 36 can greatly reduce the induction of a magnetic field due to a generated electric field as compared with an electromagnetic wave generation unit that generates a normal electromagnetic wave.

As a specific example, the drying section 36 generates electromagnetic waves of 2.4 GHz but is not limited to this. The drying section 36 may generate, for example, electromagnetic waves of 3 MHz to 300 MHz. The drying section 36 may generate, for example, electromagnetic waves of 300M to 30 GHZ, and among these, may generate electromagnetic waves of 10 MHz to 20 GHz.

The drying section 36 dries the medium 90 by heating the medium 90 from the surface 90A. More specifically, the drying section 36 heats the liquid ejected onto the medium 90 from the surface 90A of the front side. The drying section 36 dries the medium 90 by vaporizing the liquid ejected onto the medium 90. In other words, the drying section 36 is a type that drives the medium 90 regardless of whether the environment around the medium 90 is saturated with water vapor or not. Therefore, it is not necessary for the drying section 36 to blow dry gas, in which water vapor is not saturated, around the medium 90.

### Configuration of Drying Section 36

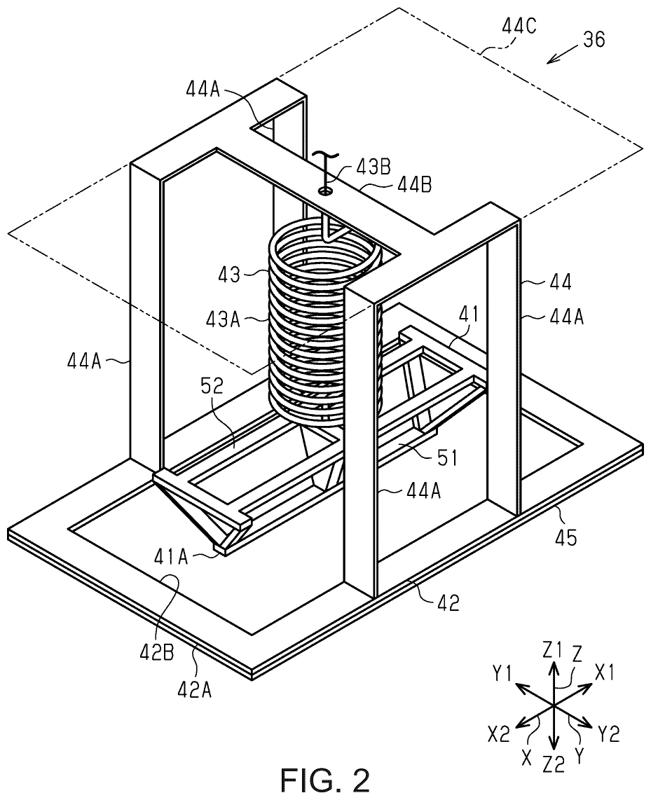

As shown in FIG. 2, the drying section 36 includes a first electrode 41, a second electrode 42, a first conductor 43, and a second conductor 44. The drying section 36 may include a facing section 45. FIG. 2 is a diagram in which the first electrode 41 and the second electrode 42 are arranged on the downward direction Z2 side.

The first electrode 41 is elongated in the width direction X in plan view. That is, the first electrode 41 extends in the width direction X in plan view. The first electrode 41 may be rectangular in plan view.

The first electrode 41 includes a first electrode surface 41A. The first electrode surface 41A is a surface facing the downward direction Z2. That is, the first electrode surface 41A is a surface facing the surface 90A of the medium 90. The first electrode 41 is arranged so that the first electrode surface 41A abuts the facing section 45.

The second electrode 42 is flat plate shaped. The second electrode 42 includes a second electrode surface 42A. The second electrode surface 42A is the surface facing the downward direction Z2. In other words, the second electrode surface 42A is a surface facing the surface 90A of the medium 90. The second electrode 42 is arranged so that the second electrode surface 42A abut the facing section 45.

The second electrode 42 includes a second electrode opening section 42B. The second electrode opening section 42B has a rectangular shape in plan view but may also have a rounded rectangular shape. The first electrode 41 is located in the second electrode opening section 42B in plan view. That is, the second electrode 42 is arranged so as to surround the first electrode 41 in plan view.

The first conductor 43 is configured to electrically couple the transmission line 32 and the first electrode 41. The first conductor 43 includes a coil 43A. The coil 43A extends in the vertical direction Z. One end of the coil 43A is coupled to the first electrode 41. The other end of the coil 43A is coupled to a lead wire 43B.

The second conductor 44 is configured to electrically couple the transmission line 32 and the second electrode 42. The second conductor 44 may include a strut 44A. The second conductor 44 may include a plurality of struts 44A. The strut 44A is electrically coupled to the second electrode 42. The strut 44A extends from the second electrode 42 to the upward direction Z1. The strut 44A is made of metal.

The second conductor 44 may include a coupling section 44B. The coupling section 44B is electrically coupled to the strut 44A. The coupling section 44B is provided at an upper end section of the strut 44A. The coupling section 44B couples the plurality of struts 44A. The coupling section 44B may be integrated with the strut 44A. The coupling section 44B may have an H-shape in plan view. The coupling section 44B is made of metal.

The second conductor 44 may include a top plate 44C. The top plate 44C is located in the upward direction Z1 of the coupling section 44B. The top plate 44C is electrically coupled to the coupling section 44B. The top plate 44C may be integrated with the coupling section 44B. The top plate 44C is made of metal.

The facing section 45 is positioned between the first electrode 41 and the second electrode 42 and the medium 90. The facing section 45 may have a flat plate shape. The facing section 45 is made of a material that transmits the electromagnetic waves generated by the drying section 36. The facing section 45 is arranged so as to face the surface 90A of the medium 90. The facing section 45 may not abut with the medium 90 or may abut with the medium 90. The facing section 45 protects the first electrode 41 and the second electrode 42. The facing section 45 is made of an insulating component. The facing section 45 may be a glass plate. The facing section 45 may be made of ceramic with high transmittance. The facing section 45 may be made of a resin with a low dielectric loss tangent. The facing section 45 may be made of polypropylene. The facing section 45 may be made of polyethylene.

By configuring the drying section 36 in this manner, when a high-frequency voltage is applied, the first electrode 41 and the second electrode 42 heat the medium 90 by generating electromagnetic waves depending on the application of the high-frequency voltage.

Such the drying section 36 can transmit large thermal energy to the medium 90 by the generation of electromagnetic waves. The drying section 36 is not of a heat conduction type but of an electromagnetic wave type and may not include a component such as a heating wire for heating. By this, it possible to reduce the size of the drying section 36.

Further, the minimum separation distance between the first electrode 41 and the second electrode 42 is equal to or less than 1/10 of the wavelength of the electromagnetic wave output from the drying section 36. By this, electromagnetic waves generated when a high-frequency voltage is applied can be attenuated in the vicinity of the first electrode 41 and the second electrode 42. By this, it is possible to reduce the intensity of the electromagnetic wave that reaches a distant place from the first electrode 41 and the second electrode 42. In other words, the electromagnetic wave generated from the drying section 36 is very strong in the vicinity of the first electrode 41 and the second electrode 42 and is very weak in a distant place.

By appropriately controlling the frequency band of the electromagnetic wave to be generated, the drying section 36 can intensively generate the AC electric field in the vicinity of the first electrode 41 and the second electrode 42. In other words, it is possible to suppress the influence on the surroundings due to the generation of the electromagnetic wave beyond the vicinity of the first electrode 41 and the second electrode 42. The vicinity of the first electrode 41 and the second electrode 42 may correspond to, for example, a range from 3 mm to 3 cm.

### Configuration of First Electrode 41

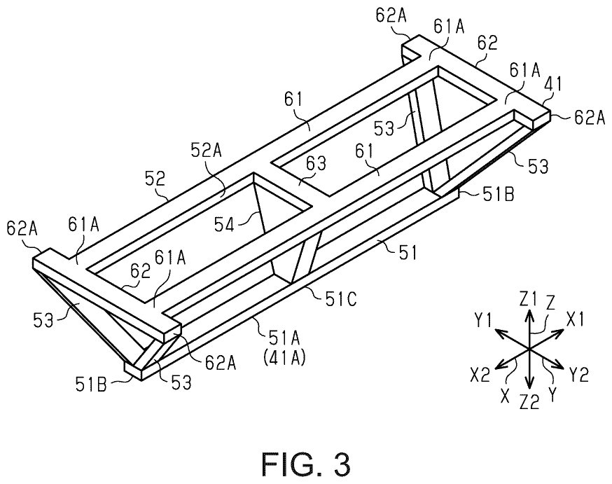

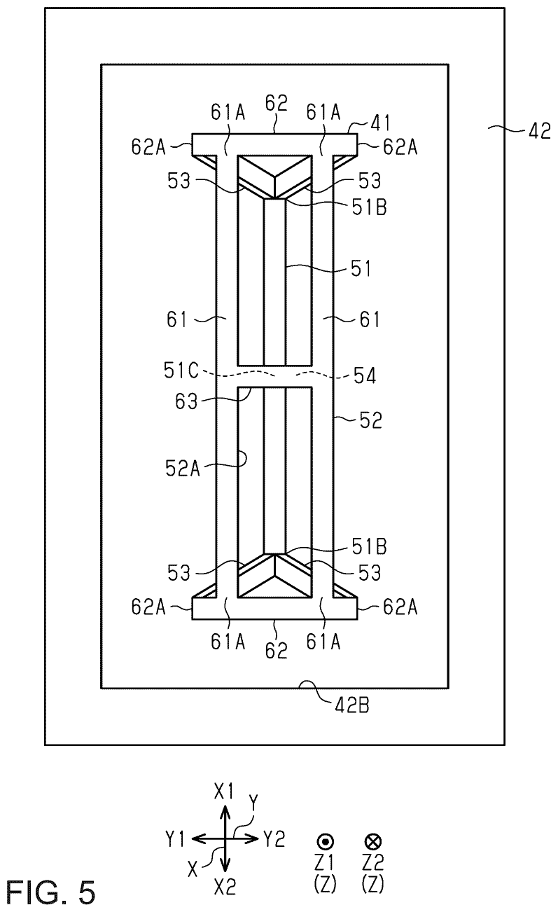

As shown in FIGS. 3 to 5, the first electrode 41 includes a first electrode section 51, a second electrode section 52, a first conductor section 53, and a second conductor section 54. The first electrode section 51, the second electrode section 52, the first conductor section 53, and the second conductor section 54 are conductors with conductivity. The first electrode section 51, the second electrode section 52, the first conductor section 53, and the second conductor section 54 are configured as separate entities, but at least any combination thereof may be integrated.

The first electrode section 51 extends in the width direction X. The first electrode section 51 has a flat plate shape but may also be rod shaped. The first electrode section 51 may be shorter than the second electrode section 52 in the width direction X.

The first electrode section 51 includes a bottom surface 51A. The bottom surface 51A constitutes the first electrode surface 41A of the first electrode 41. The first electrode section 51 includes both end sections 51B and a first central section 51C. The both end sections 51B are both end sections of the first electrode section 51 in the width direction X. The first central section 51C is arranged at the center in the width direction X of the first electrode section 51. The first central section 51C is arranged so as to be sandwiched between both end sections 51B in the width direction X.

The second electrode section 52 is provided in the upward direction Z1 from the first electrode section 51. The second electrode section 52 extends in the width direction X. The second electrode section 52 is configured to have a substantially rectangular shape in plan view but is not limited thereto.

The second electrode section 52 includes a pair of girder sections 61 and a pair of beam sections 62. Each of the pair of girder sections 61 extends in the width direction X. The pair of girder sections 61 are arranged side by side in the depth direction Y. The pair of girder sections 61 constitute both long sides of the second electrode section 52 in plan view. The pair of girder sections 61 have a flat plate shape but may have a rod shape.

The pair of beam sections 62 extends in the depth direction Y. The pair of beam sections 62 are arranged side by side in the width direction X. The pair of beam sections 62 constitutes both short sides of the second electrode section 52 in plan view. The pair of beam sections 62 has a flat plate shape but may also be rod shaped.

Both end sections 61A of the pair of girder sections 61 are coupled to the pair of beam sections 62. Both end sections 62A of the pair of beam sections 62 protrude outward in the depth direction Y from the pair of girder sections 61. In such a case, both end sections 62A of the pair of beam sections 62 constitute corner portions of the second electrode section 52.

The pair of girder sections 61 and the pair of beam sections 62 constitute an opening section 52A. In other words, the second electrode section 52 includes the opening section 52A. The first electrode section 51 is located in the opening section 52A in plan view. By this, the opening section 52A overlaps the first electrode section 51 in plan view. In detail, the pair of girder sections 61 and the pair of beam sections 62 surround the first electrode section 51 in plan view. By this, the second electrode section 52 surrounds the first electrode section 51 in plan view.

The second electrode section 52 includes a second central section 63. The second central section 63 is positioned at the center between the pair of girder sections 61 in the width direction X. The second central section 63 is located between the pair of beam sections 62 in the width direction X. By this, the second central section 63 is located at the center of the second electrode section 52 in the width direction X.

The second central section 63 is configured to couple the pair of girder sections 61 in the depth direction Y. The second central section 63 extends in the depth direction Y so as to straddle the opening section 52A. The second central section 63 is a central beam section parallel to the pair of beam sections 62.

The first conductor 43 is coupled to the second central section 63. Specifically, one end of the coil 43A is coupled to the second central section 63. By this, the first conductor 43 is coupled to the second central section 63.

The first conductor section 53 couples the first electrode section 51 and the second electrode section 52. In detail, the first conductor section 53 couples both end sections 51B and both end sections 62A. In other words, the first conductor section 53 extends from both end sections 51B to the corner portions of the second electrode section 52.

The first conductor section 53 extends from both end sections 51B to the upward direction Z1 so as to be inclined outward with respect to the width direction X. The first conductor section 53 is configured to have a V-shape when viewed in the width direction X. The first conductor section 53 extends from both end sections 51B to the upward direction Z1 so as to be inclined outward with respect to the depth direction Y. The first conductor section 53 is configured to have a V-shape in plan view. By this, the first conductor section 53 is coupled to the second electrode section 52 so as to branch from both end sections 51B of the first electrode section 51.

The second conductor section 54 couples the first electrode section 51 and the second electrode section 52. In detail, the second conductor section 54 couples the first central section 51C of the first electrode section 51 and the second central section 63 of the second electrode section 52.

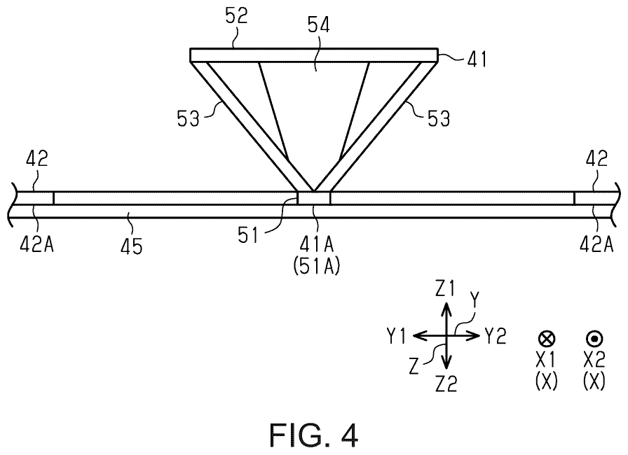

As shown in FIG. 4, the first electrode section 51 is located at the same height as the second electrode 42 in the vertical direction Z. In other words, the first electrode section 51 is arranged at a position overlapping the second electrode 42 in the vertical direction Z.

The second electrode section 52 is positioned in the upward direction Z1 above the second electrode 42 in the vertical direction Z. In other words, the second electrode section 52 is arranged at a position that does not overlap the second electrode 42 in the vertical direction Z. The medium 90 is transported to the downward direction Z2 of, that is, below, the first electrode 41 and second electrode 42. That is, the second electrode section 52 is arranged at a position separated from the medium 90.

### PRESENT EMBODIMENT

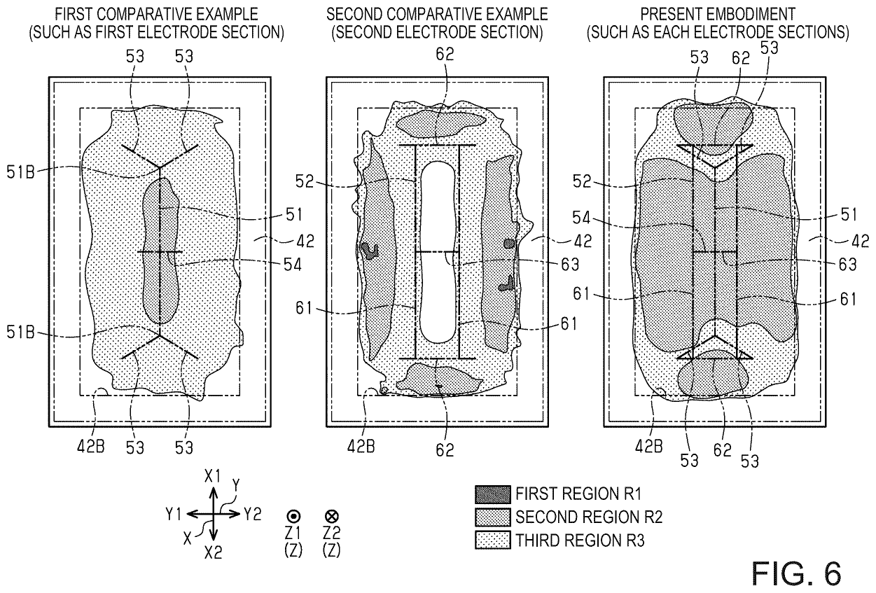

Here, a comparative example and a present embodiment will be described with reference to FIG. 6. FIG. 6 is a diagram showing the heating amount in each region in the first comparative example, the second comparative example, and the present embodiment. FIG. 6 is a diagram illustrating the first region R1, the second region R2, and the third region R3 in descending order of the heating amount. In FIG. 6, the center position of the configuration of the first electrode 41 and the configuration of the second electrode 42 are indicated by a two-dot chain line.

As shown in FIG. 6, in the first comparative example, the first electrode 41 is composed of the first electrode section 51, the first conductor section 53, and the second conductor section 54. In the first comparative example, the heating amount increases along the first electrode section 51 in the region surrounded by the second electrode 42 in plan view.

On the other hand, in the first comparative example, the heating amount does not increase in the region other than the region along the first electrode section 51 in the region surrounded by the second electrode 42 in plan view, and the heating amount does not further increase when the distance from the first electrode section 51 increases.

In comparison with the case where the first electrode 41 is configured only by the first electrode section 51 as in the related art, the first conductor section 53 is provided in the first comparative example. As a result, in the first comparative example, the concentration of the electromagnetic waves is avoided in the region in the vicinity of both end sections 51B, and thus the heating amount can be equalized. However, the heating amount is not increased in the other regions, and the total heating amount is relatively decreased.

In the second comparative example, the first electrode 41 is configured from the second electrode section 52. In the second comparative example, in the region surrounded by the second electrode 42 in plan view, the heating amount becomes extremely large along the second electrode opening section 42B.

On the other hand, in the second comparative example, the heating amount does not increase in the region surrounded by the pair of girder sections 61 and the pair of beam sections 62 in the region surrounded by the second electrode 42 in plan view. As described above, in the second comparative example, the heating amount is not equalized.

In the present embodiment, the first electrode 41 is composed of the first electrode section 51, the second electrode section 52, the first conductor section 53, and the second conductor section 54. In other words, in the present embodiment, the configuration of the second comparative example is added to the configuration of the first comparative example.

In the present embodiment, in the region surrounded by the second electrode 42 in plan view, the difference in the heating amount is smaller than in the first comparative example and the second comparative example, and the heating amount can be made more uniform. In addition, in the present embodiment, the total heating amount does not become relatively small.

As described above, in the present embodiment, it is possible to reduce the heating amount in the vicinity region of both end sections 51B by the first comparative example and to reduce the heating amount in the vicinity region of the first electrode section 51 by the second comparative example, while increasing the heating amount in the other regions. As a result, the heating amount can be further equalized, and the overall heating amount does not become relatively small.

Further, when the heating amount of the first comparative example and the heating amount of the second comparative example are compared under the same conditions, the heating amount of the second comparative example is about twice the heating amount of the first comparative example. For this reason, in the vertical direction Z, the first electrode section 51 is arranged at positions overlapping the second electrode 42, and the second electrode section 52 is disposed at positions away from the first electrode section 51 in the upward direction Z1. As a result, the heating amount can be further equalized, and the overall heating amount does not become relatively small.

### Operation and Effect of First Embodiment

Operations and effects of the first embodiment will be described.

1: In the related art, the first electrode is provided to extend in the width direction X, and a strong electric field region tends to be concentrated in a region in the vicinity of the both end sections of the first electrode, for example, by the same principle as that of corona discharge. By this, the heating amount is large in the regions in the vicinity of both end sections of the first electrode, but the heating amount is small in the other regions. By this, since the heating amount becomes uneven depending on the region, the drying degree of the medium becomes uneven.

Thus, the first electrode 41 includes the first electrode section 51 and the second electrode section 52. The first electrode section 51 is arranged at a position overlapping the second electrode 42 in the vertical direction Z. The second electrode section 52 is arranged at a position that does not overlap the second electrode 42 in the vertical direction Z and is separated from the medium 90. The second electrode section 52 surrounds the first electrode section 51 in plan view.

According to this configuration, by using the first electrode section 51 and the second electrode section 52, it is possible to avoid the concentration of electromagnetic waves in the vicinity region of the first electrode section 51, while it is possible to increase the electromagnetic waves in the surrounding region surrounding the first electrode section 51. Thus, the electromagnetic waves to be generated can be equalized. Therefore, it is possible to suppress unevenness in the drying degree of the medium 90. It is also possible to suppress an electric discharge between the first electrode 41 and the second electrode 42 by equalizing the generated electromagnetic waves. It is possible to suppress a decrease in the intensity of the electromagnetic wave to be generated. Therefore, it is also possible to suppress a decrease in the drying efficiency of medium 90.

2: The first conductor section 53 is coupled to the second electrode section 52 so as to branch from both end sections 51B of the first section 51. According to this configuration, since the first conductor section 53 is coupled to the second electrode section 52 so as to branch from both end sections 51B, it is possible to avoid concentration of electromagnetic waves at both end sections 51B. Thus, the electromagnetic waves to be generated can be equalized. Therefore, it is possible to suppress unevenness in the drying degree of the medium 90.

3: The first conductor section 53 extends from both end sections 51B to the second electrode section 52 so as to be inclined outward with respect to the width direction X and inclined outward with respect to the depth direction Y. According to this configuration, since the first conductor section 53 extends from both end sections 51B so as to be inclined outward with respect to the width direction X and the depth direction Y, it is possible to further avoid concentration of electromagnetic waves on both end sections 51B. Thus, the electromagnetic waves to be generated can be equalized. Therefore, it is possible to suppress unevenness in the drying degree of the medium 90.

4: The first conductor section 53 extends from both end sections 51B to both end sections 62A as corner portions of the second electrode section 52. According to this configuration, it is possible to increase electromagnetic waves generated in a region separated from the first electrode section 51 in the width direction X and the depth direction Y. Thus, the electromagnetic waves to be generated can be equalized. Therefore, it is possible to suppress unevenness in the drying degree of the medium 90.

5: The second electrode section 52 includes the opening section 52A. The opening section 52A overlaps the first electrode section 51 in plan view. According to this configuration, since the opening section 52A is arranged at a position overlapping the first electrode section 51 in plan view, it is possible to suppress electromagnetic waves generated in the vicinity region of the first electrode section 51. Thus, the electromagnetic waves to be generated can be equalized. Therefore, it is possible to suppress unevenness in the drying degree of the medium 90.

6: The first electrode 41 includes the second conductor section 54. The second conductor section 54 couples the first central section 51C of the first electrode section 51 and the second central section 63 of the second electrode section 52. According to this configuration, it is possible to stably couple the first electrode section 51 and the second electrode section 52.

7: The first conductor 43 is coupled to the second central section 63. According to this configuration, a configuration in which the first conductor 43 and the first electrode 41 are easily coupled to each other can be realized.

### MODIFIED EXAMPLE

The present embodiment can be implemented with the following modifications. The present embodiment and the following modified example can be implemented in combination with each other as long as there is no technical contradiction.
As long as the first electrode 41 includes the first electrode section 51 and the second electrode section 52, the first electrode section 51 and the second electrode section 52 may be coupled in any configuration. In particular, the first electrode 41 can equalize the intensity of the electromagnetic waves in the same manner regardless of the presence or absence of the space as long as the positions of the respective end sections such as both end sections 51B and both end sections 62A are the same.

As a specific example, the first electrode section 51 and the second electrode section 52 may be coupled to each other by another conductor section different from the first conductor section 53 and the second conductor section 54. In other words, a third conductor section may be further provided between the first conductor section 53 and the second conductor section 54 in the width direction X. The third conductor section may have a similar shape to the second conductor section 54 when viewed from the width direction X and may be smaller than the second conductor section 54. A plurality of third conductors may be provided. With this configuration, the intensity of the electromagnetic wave can be made more uniform. The first electrode 41 may not include one of the first conductor section 53 and the second conductor section 54. The first electrode 41 may include an integrated conductor section comprising the first conductor section 53 and the second conductor section 54.
The second electrode section 52 may not include the opening section 52A. In such a case, the second electrode section 52 is arranged so as to overlap the first electrode section 51 in plan view. In other words, it can be said that the second electrode section 52 surrounds the first electrode section 51 in plan view.
The both end sections 62A of the pair of beam sections 62 may not protrude from the pair of girder sections 61 in the depth direction Y, and both end sections 61A of the pair of girder sections 61 may not protrude from the pair of beam sections 62 in the width direction X. In such a case, both end sections 61A of the pair of girder sections 61 and both end sections 62A of the pair of beam sections 62 constitute corner portions of the second electrode section 52.

The both end sections 61A of the pair of girder sections 61 may protrude outward from the pair of beam sections 62 in the width direction X. In such a case, both end sections 61A of the pair of girder sections 61 constitute the corner sections of the second electrode section 52.
The first electrode section 51 may be composed of multiple components. The second electrode section 52 may be constituted by a plurality of components. As a specific example, the second electrode section 52 may be constitute including at least any combination of the pair of girder sections 61, the pair of beam sections 62, and the second central section 63 as separate bodies.
The drying section 36 may be arranged so that the depth direction Y is the longitudinal direction. That is, the depth direction Y may be an example of the second direction. The width direction X may be an example of a third direction. The drying section 36 may be arranged so as to be inclined with respect to the width direction X and the depth direction Y. A direction inclined with respect to the width direction X and the depth direction Y may be an example of the second direction.
The drying unit 30 may include the plurality of drying sections 36. The plurality of drying sections 36 may be arranged in a plurality of rows in the width direction X. The plurality of drying sections 36 may be arranged in a plurality of rows in the depth direction Y.
The drying section 36 may be arranged on the back surface 90B side of the medium 90. The drying section 36 may be arranged on both the surface 90A of the medium 90 and the back surface 90B of the medium 90. The drying section 36 may be scannable in the width direction X.
The drying section 36 may be arranged separately from the facing section 45. In other words, the drying section 36 may not include the facing section 45. In this case, it is preferable for the facing section 45 to be arranged between the first electrode 41 and the second electrode, and the medium 90.
The second electrode 42 is not limited to a flat plate shape and may be, for example, a substantially flat plate shape. The substantially flat plate shape has, for example, a shape curved in the thickness direction which is a direction along the vertical direction Z or a rectangular shape having an extremely large aspect ratio and may include a linear shape.
At least one of the first electrode surface 41A and the second electrode surface 42A is not limited to the planar shape and may be a substantially planar shape. The substantially planar shape has, for example, a shape curved in the thickness direction which is a direction along the vertical direction Z or a rectangular shape having an extremely large aspect ratio and may include a linear shape.
The drying section 36 may not be provided in the drying device 12 and may be provided in the recording device 11. That is, the recording device 11 may include the drying section 36. In this case, the drying section 36 may be provided on the downstream of the recording section 20 in the transport direction D. In this manner, the drying section 36 may be applied to the recording device 11 instead of the drying device 12.
A lateral-type printer may be adopted as the recording device 11. The lateral-type printer is a printer in which the carriage 25 is movable in two directions, the main scanning direction and the sub-scanning direction.
The medium 90 is not limited to a roll body. The medium 90 may be paper sheet, a resin film or sheet, a resin-metal composite film, a laminate film, a woven fabric, a nonwoven fabric, a metal foil, a metal film, a ceramic sheet, clothing, or the like.

The liquid can be arbitrarily selected as long as it can be recorded on the medium 90 by attaching it to the medium 90. For example, the ink includes an ink in which particles of a functional material made of a solid material such as a pigment or metal particles are dissolved, dispersed, or mixed in a solvent, and includes various compositions such as a water-based ink, an oil-based ink, a gel ink, and a hot-melt ink.
As used herein, the phrase “at least one of” means one or more of the desired alternatives. As an example, the phrase “at least one of” as used herein means only one option if the number of options is two, or both of the two options. As another example, the phrase “at least one of” as used herein means only one option or any combination of two or more options, as long as the number of options is three or more.

### NOTES

Hereinafter, technical ideas grasped from the above-described embodiment and modified example, and operational effects thereof will be described. The present technical idea and the operational effects thereof can be combined with each other within a technically consistent range.

(A) The drying device includes a drying section that dries the medium onto which liquid is ejected, by generating electromagnetic waves according to on an applied high-frequency voltage, wherein the drying section has a first electrode, a second electrode arranged so as to surround the first electrode in plan view from a first direction toward a medium, a first conductor electrically connecting the first electrode to a transmission line including a coil and configured to transmit a high-frequency voltage, and a second conductor electrically coupling the transmission line and the second electrode, and the first electrode includes a first electrode section arranged at a position overlapping the second electrode in the first direction and a second electrode section arranged at a position that does not overlap the second electrode in the first direction and that is separated from the medium in the first direction, the second electrode section surrounding the first electrode section in plan view from the first direction.

According to this configuration, by using the first electrode section and the second electrode section, it is possible to avoid the concentration of electromagnetic waves in the region in the vicinity of the first electrode section, and on the other hand, it is possible to increase the electromagnetic waves in the surrounding region surrounding the first electrode section. Thus, the electromagnetic waves to be generated can be equalized. Therefore, it is possible to suppress unevenness in the drying degree of the medium. Further, by the equalization of the generated electromagnetic waves, the electric discharge between the first electrode and the second electrode can also be suppressed. It is possible to suppress a decrease in the intensity of the electromagnetic wave to be generated. Therefore, it is also possible to suppress a decrease in the drying efficiency of the medium.

(B) In the above-described drying device, the first electrode extends in a second direction intersecting the first direction and includes a first conductor section and the first conductor section may be coupled to the second electrode section so as to branch from both end sections of the first electrode section in the second direction.

According to this configuration, since the first conductor section is coupled to the second electrode section so as to be branched from both end sections of the first electrode section, it is possible to avoid concentration of electromagnetic waves at both end sections of the first electrode section. Thus, the electromagnetic waves to be generated can be equalized. Therefore, it is possible to suppress unevenness in the drying degree of the medium.

(C) In the above-described drying device, the first conductor section may incline outward with respect to the second direction and also may extend from both end sections of the first electrode section to the second electrode section so as to incline outward with respect to a third direction intersecting the first direction and the second direction.

According to this configuration, since the first conductor section extends from both end sections of the first electrode section so as to be inclined outward with respect to the second direction and the third direction, it is possible to further avoid the concentration of electromagnetic waves on both end sections of the first electrode section. Thus, the electromagnetic waves to be generated can be equalized. Therefore, it is possible to suppress unevenness in the drying degree of the medium.

(D) In the above-described drying device, the first conductor section may extend from both end sections of the first electrode section to the corners of the second electrode section.

According to this configuration, it is possible to increase an electromagnetic wave generated in a region separated from the first electrode section with respect to the second direction and the third direction. Thus, the electromagnetic waves to be generated can be equalized. Therefore, it is possible to suppress unevenness in the drying degree of the medium.

(E) In the above-described drying device, the second electrode section includes an opening section, and the opening section may overlap with the first electrode section in plan view from the first direction.

According to this configuration, since the opening section is provided at the position overlapping the first electrode section in plan view from the first direction, it is possible to suppress the electromagnetic wave generated in the region in the vicinity of the first electrode section. Thus, the electromagnetic waves to be generated can be equalized. Therefore, it is possible to suppress unevenness in the drying degree of the medium.

(F) In the above-described drying device, the first electrode includes a second conductor section that may couple together a first central section of the first electrode section in a second direction intersecting the first direction and a second central section of the second electrode section in the second direction.

According to this configuration, the first electrode section and the second electrode section can be stably coupled to each other.

(G) In the above-described drying device, the first conductor may be coupled to the second central section.

According to this configuration, it is possible to realize a configuration in which the first conductor and the first electrode are easily coupled to each other.

(h) The recording device includes a recording section configured to perform recording by ejecting liquid onto a medium and a drying section that dries the medium, onto which liquid was ejected by the recording section, by generating electromagnetic waves according to an applied high-frequency voltage, wherein the drying section has a first electrode, a second electrode arranged so as to surround the first electrode in plan view from a first direction toward a medium, a first conductor electrically connecting the first electrode to a transmission line including a coil and configured to transmit a high-frequency voltage, and a second conductor electrically coupling the transmission line and the second electrode, and the first electrode includes a first electrode section arranged at a position overlapping the second electrode in the first direction and a second electrode section arranged at a position that does not overlap the second electrode in the first direction and that is separated from the medium in the first direction, the second electrode section surrounding the first electrode section in plan view from the first direction. According to this configuration, the same effect as in (A) can be achieved.

What is claimed is:

1. A drying device comprising:
a drying section that dries the medium onto which liquid is ejected, by generating electromagnetic waves according to on an applied high-frequency voltage, wherein
the drying section includes
a first electrode,
a second electrode arranged so as to surround the first electrode in plan view from a first direction toward a medium,
a first conductor electrically connecting the first electrode to a transmission line including a coil and configured to transmit a high-frequency voltage, and
a second conductor electrically coupling the transmission line and the second electrode, and
the first electrode includes
a first electrode section arranged at a position overlapping the second electrode in the first direction and
a second electrode section arranged at a position that does not overlap the second electrode in the first direction and that is separated from the medium in the first direction, the second electrode section surrounding the first electrode section in plan view from the first direction.

2. The drying device according to claim 1, wherein
the first electrode extends in a second direction intersecting the first direction and includes a first conductor section and
the first conductor section is coupled to the second electrode section so as to branch from both end sections of the first electrode section in the second direction.

3. The drying device according to claim 2, wherein
the first conductor section inclines outward with respect to the second direction and also extends from both end sections of the first electrode section to the second electrode section so as to incline outward with respect to a third direction intersecting the first direction and the second direction.

4. The drying device according to claim 3, wherein
the first conductor section extends from both end sections of the first electrode section to corners of the second electrode section.

5. The drying device according to claim 1, wherein
the second electrode section includes an opening section that overlaps with the first electrode section in plan view from the first direction.

6. The drying device according to claim 1, wherein
the first electrode includes a second conductor section that couples together a first central section of the first electrode section in a second direction intersecting the first direction and a second central section of the second electrode section in the second direction.

7. The drying device according to claim 6, wherein
the first conductor is coupled to the second central section.

8. A recording device comprising:
a recording section configured to perform recording by ejecting liquid onto a medium and
a drying section that dries the medium, onto which liquid was ejected by the recording section, by generating electromagnetic waves according to an applied high-frequency voltage, wherein
the drying section includes
a first electrode,
a second electrode arranged so as to surround the first electrode in plan view from a first direction toward a medium,
a first conductor electrically connecting the first electrode to a transmission line including a coil and configured to transmit a high-frequency voltage, and
a second conductor electrically coupling the transmission line and the second electrode, and
the first electrode includes
a first electrode section arranged at a position overlapping the second electrode in the first direction and
a second electrode section arranged at a position that does not overlap the second electrode in the first direction and that is separated from the medium in the first direction, the second electrode section surrounding the first electrode section in plan view from the first direction.
